(19) United States
(12) Patent Application Publication
(10) Pub. No.: US 2025/0192300 A1
(43) Pub. Date: Jun. 12, 2025

(54) WRAPPED THERMAL BARRIER ASSEMBLIES FOR ESTABLISHING SEALED INTERFACES WITHIN TRACTION BATTERY PACKS

(71) Applicant: FORD GLOBAL TECHNOLOGIES, LLC, Dearborn, MI (US)

(72) Inventors: Zachary O. Baker, Dearborn, MI (US); Mohammadreza Eftekhari, Novi, MI (US); Jason C. Marcath, Dearborn, MI (US)

(21) Appl. No.: 18/780,904

(22) Filed: Jul. 23, 2024

Related U.S. Application Data
(60) Provisional application No. 63/607,888, filed on Dec. 8, 2023.

(51) Int. Cl. H01M 50/24; B60L 50/64; H01M 10/613; H01M 10/625; H01M 10/647; H01M 10/653; H01M 10/6554; H01M 50/211; H01M 50/271; H01M 50/289

(52) U.S. Cl. CPC H01M 50/24; B60L 50/64; H01M 10/613; H01M 10/625; H01M 10/647; H01M 10/653; H01M 10/6554; H01M 50/211; H01M 50/271; H01M 50/289; H01M 2220/20

(57) ABSTRACT

Thermal barrier assemblies are configured for inhibiting the transfer of thermal energy inside a traction battery pack. The thermal barrier assemblies may be further configured for establishing a sealed interface between the thermal barrier assembly and one or more perimeter environments. An exemplary thermal barrier assembly may include a structural barrier, and a thermal resistance material wrapping that is wrapped around at least one edge of the structural barrier.

### CROSS-REFERENCE TO RELATED APPLICATIONS

This disclosure claims priority to U.S. Provisional Application No. 63/607,888, which was filed on Dec. 8, 2023 and is incorporated herein by reference in its entirety.

### TECHNICAL FIELD

This disclosure relates generally to traction battery packs, and more particularly to wrapped thermal barrier assemblies the can function to both mitigate the transfer of thermal energy with the traction battery pack and establish a sealed interface relative to a perimeter environment.

### BACKGROUND

Electrified vehicles include a traction battery pack for powering electric machines and other electrical loads of the vehicle. The traction battery pack includes a plurality of battery cells and various other battery internal components that support electric vehicle propulsion.

### SUMMARY

A traction battery pack according to an exemplary aspect of the present disclosure includes, among other things, a thermal barrier assembly arranged to partition a battery cell stack into a first compartment and a second compartment. The thermal barrier assembly includes a structural barrier and a thermal resistance material wrapping that is wrapped around at least one edge of the structural barrier.

In a further non-limiting embodiment of the foregoing traction battery pack, the thermal resistance material wrapping is wrapped around a bottom edge of the structural barrier to seal an interface between the thermal barrier assembly and a lower enclosure structure of the traction battery pack.

In a further non-limiting embodiment of either of the foregoing traction battery packs, the lower enclosure structure is part of a heat exchanger plate.

In a further non-limiting embodiment of any of the foregoing traction battery packs, the thermal resistance material wrapping is wrapped around a top edge of the structural barrier to seal an interface between the thermal barrier assembly and an upper enclosure structure of the traction battery pack.

In a further non-limiting embodiment of any of the foregoing traction battery packs, the upper enclosure structure is part of an enclosure cover of an enclosure assembly of the traction battery pack.

In a further non-limiting embodiment of any of the foregoing traction battery packs, the thermal resistance material wrapping is wrapped around a top edge of the structural barrier to seal a first interface between the thermal barrier assembly and an upper enclosure structure of the traction battery pack and is further wrapped around a bottom edge of the structural barrier to seal a second interface between the thermal barrier assembly and a lower enclosure structure of the traction battery pack.

In a further non-limiting embodiment of any of the foregoing traction battery packs, the thermal resistance material wrapping is wrapped around a lateral side edge of the structural barrier to seal an interface between the thermal barrier assembly and a cross-member assembly of the battery cell stack.

In a further non-limiting embodiment of any of the foregoing traction battery packs, the thermal resistance material wrapping is wrapped around a first lateral side edge of the structural barrier to seal a first interface between the thermal barrier assembly and a first cross-member assembly of the battery cell stack and is further wrapped around a second lateral side edge of the structural barrier to seal a second interface between the thermal barrier assembly and a second cross-member assembly of the battery cell stack.

In a further non-limiting embodiment of any of the foregoing traction battery packs, the thermal resistance material wrapping is wrapped around a top edge of the structural barrier to seal a first interface between the thermal barrier assembly and an upper enclosure structure of the traction battery pack, is further wrapped around a bottom edge of the structural barrier to seal a second interface between the thermal barrier assembly and a lower enclosure structure of the traction battery pack, is further wrapped around a first lateral side edge of the structural barrier to seal a third interface between the thermal barrier assembly and a first cross-member assembly of the battery cell stack, and is further wrapped around a second lateral side edge of the structural barrier to seal a fourth interface between the thermal barrier assembly and a second cross-member assembly of the battery cell stack.

In a further non-limiting embodiment of any of the foregoing traction battery packs, the thermal resistance material wrapping includes a first section that covers a majority of a first major side face of the structural barrier, a second section that covers a majority of a second major side face of the structural barrier, and a sealing section that connects between the first section and the second section.

In a further non-limiting embodiment of any of the foregoing traction battery packs, the thermal barrier assembly includes a first foam layer that flanks the first section of the thermal resistance material wrapping, and a second foam layer that flanks the second section of the thermal resistance material wrapping.

In a further non-limiting embodiment of any of the foregoing traction battery packs, an adhesive is applied between the thermal resistance material wrapping and a perimeter environment.

In a further non-limiting embodiment of any of the foregoing traction battery packs, the structural barrier includes a pultrusion.

A traction battery pack according to another exemplary aspect of the present disclosure includes, among other things, an upper enclosure structure, a lower enclosure structure, a first cross-member assembly, a second cross-member assembly, a first grouping of battery cells and a second grouping of battery cells arranged to extend between the upper enclosure structure and the lower enclosure structure and between the first cross-member assembly and the second cross-member assembly, and a thermal barrier assembly positioned to separate the first grouping of battery cells from the second grouping of battery cells. The thermal barrier assembly includes a structural barrier and a thermal resistance material wrapping arranged about at least one edge of the structural barrier to seal an interface between the thermal barrier assembly and at least one of the upper enclosure structure, the lower enclosure structure, the first cross-member assembly, or the second cross-member assembly.

In a further non-limiting embodiment of the foregoing traction battery pack, the thermal resistance material wrapping is wrapped around a bottom edge of the structural barrier to seal the interface between the thermal barrier assembly and the lower enclosure structure.

In a further non-limiting embodiment of either of the foregoing traction battery packs, the thermal resistance material wrapping is wrapped around a top edge of the structural barrier to seal the interface between the thermal barrier assembly and the upper enclosure structure.

In a further non-limiting embodiment of any of the foregoing traction battery packs, the thermal resistance material wrapping is wrapped around a top edge of the structural barrier to seal a first interface between the thermal barrier assembly and the upper enclosure structure and is further wrapped around a bottom edge of the structural barrier to seal a second interface between the thermal barrier assembly and the lower enclosure structure.

In a further non-limiting embodiment of any of the foregoing traction battery packs, the thermal resistance material wrapping is wrapped around a first lateral side edge of the structural barrier to seal a first interface between the thermal barrier assembly and the first cross-member assembly and is further wrapped around a second lateral side edge of the structural barrier to seal a second interface between the thermal barrier assembly and the second cross-member assembly.

In a further non-limiting embodiment of any of the foregoing traction battery packs, the thermal resistance material wrapping is wrapped around a top edge of the structural barrier to seal a first interface between the thermal barrier assembly and the upper enclosure structure, is further wrapped around a bottom edge of the structural barrier to seal a second interface between the thermal barrier assembly and the lower enclosure structure, is further wrapped around a first lateral side edge of the structural barrier to seal a third interface between the thermal barrier assembly and the first cross-member assembly, and is further wrapped around a second lateral side edge of the structural barrier to seal a fourth interface between the thermal barrier assembly and the second cross-member assembly.

In a further non-limiting embodiment of any of the foregoing traction battery packs, an adhesive is applied between a portion of the thermal resistance material wrapping that is arranged about the at least one edge of the structural barrier and the upper enclosure structure, the lower enclosure structure, the first cross-member assembly, or the second cross-member assembly.

The embodiments, examples, and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

The various features and advantages of this disclosure will become apparent to those skilled in the art from the following detailed description. The drawings that accompany the detailed description can be briefly described as follows.

### BRIEF DESCRIPTION OF THE DRAWINGS

FIG. 1 schematically illustrates an electrified vehicle.

FIG. 2 is an exploded perspective view of a traction battery pack for an electrified vehicle.

FIG. 3 is a cross-sectional view illustrating select portions of a cell stack of a traction battery pack.

FIG. 4 illustrates an exemplary thermal barrier assembly of the cell stack of FIG. 3.

FIG. 5 illustrates select portions of another exemplary cell stack.

FIG. 6 illustrates select portions of yet another exemplary cell stack.

FIGS. 7 and 8 illustrate another exemplary thermal barrier assembly.

FIGS. 9, 10, and 11 illustrate yet another exemplary thermal barrier assembly.

### DETAILED DESCRIPTION

This disclosure details thermal barrier assemblies configured for inhibiting the transfer of thermal energy inside a traction battery pack. The thermal barrier assemblies may be further configured for establishing a sealed interface between the thermal barrier assembly and one or more perimeter environments. An exemplary thermal barrier assembly may include a structural barrier, and a thermal resistance material wrapping that is wrapped around at least one edge of the structural barrier. These and other features are discussed in greater detail in the following paragraphs of this detailed description.

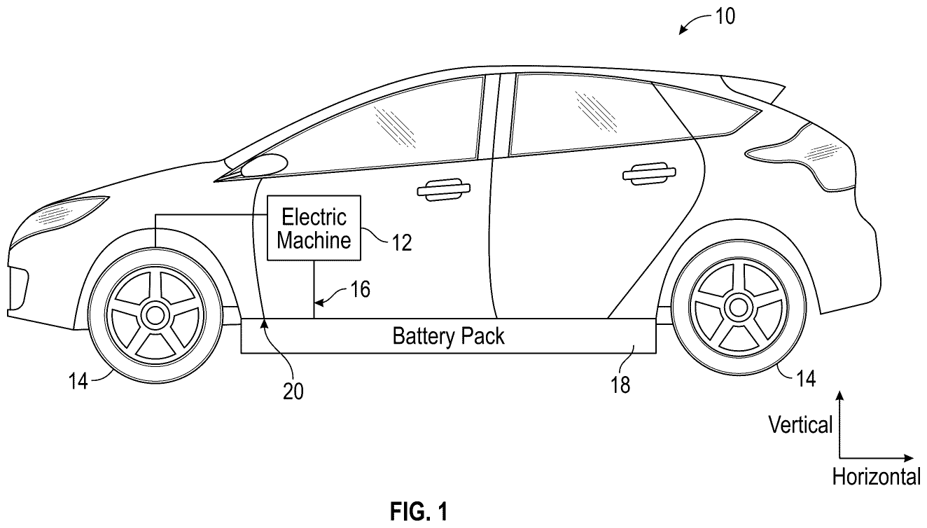

FIG. 1 schematically illustrates an electrified vehicle 10. The electrified vehicle 10 may include any type of electrified powertrain. In an embodiment, the electrified vehicle 10 is a battery electric vehicle (BEV). However, the concepts described herein are not limited to BEVs and could extend to other electrified vehicles, including, but not limited to, hybrid electric vehicles (HEVs), plug-in hybrid electric vehicles (PHEV's), fuel cell vehicles, etc. Therefore, although not specifically shown in the exemplary embodiment, the powertrain of the electrified vehicle 10 could be equipped with an internal combustion engine that can be employed either alone or in combination with other power sources to propel the electrified vehicle 10.

In the illustrated embodiment, the electrified vehicle 10 is depicted as a car. However, the electrified vehicle 10 could alternatively be a sport utility vehicle (SUV), a van, a pickup truck, or any other vehicle configuration. Although a specific component relationship is illustrated in the figures of this disclosure, the illustrations are not intended to limit this disclosure. The placement and orientation of the various components of the electrified vehicle 10 are shown schematically and could vary within the scope of this disclosure. In addition, the various figures accompanying this disclosure are not necessarily drawn to scale, and some features may be exaggerated or minimized to emphasize certain details of a particular component, assembly, or system.

In the illustrated embodiment, the electrified vehicle 10 is a full electric vehicle propelled solely through electric power, such as by one or more electric machines 12, without assistance from an internal combustion engine. The electric machine 12 may operate as an electric motor, an electric generator, or both. The electric machine 12 receives electrical power and can convert the electrical power to torque for driving one or more wheels 14 of the electrified vehicle 10.

A voltage bus 16 may electrically couple the electric machine 12 to a traction battery pack 18. The traction battery pack 18 is an exemplary electrified vehicle battery. The traction battery pack 18 may be a high voltage traction battery pack assembly that includes a plurality of battery cells capable of outputting electrical power to power the electric machine 12 and/or other electrical loads of the electrified vehicle 10. Other types of energy storage devices and/or output devices could alternatively or additionally be used to electrically power the electrified vehicle 10.

The traction battery pack 18 may be secured to an underbody 20 of the electrified vehicle 10. However, the traction battery pack 18 could be located elsewhere on the electrified vehicle 10 within the scope of this disclosure.

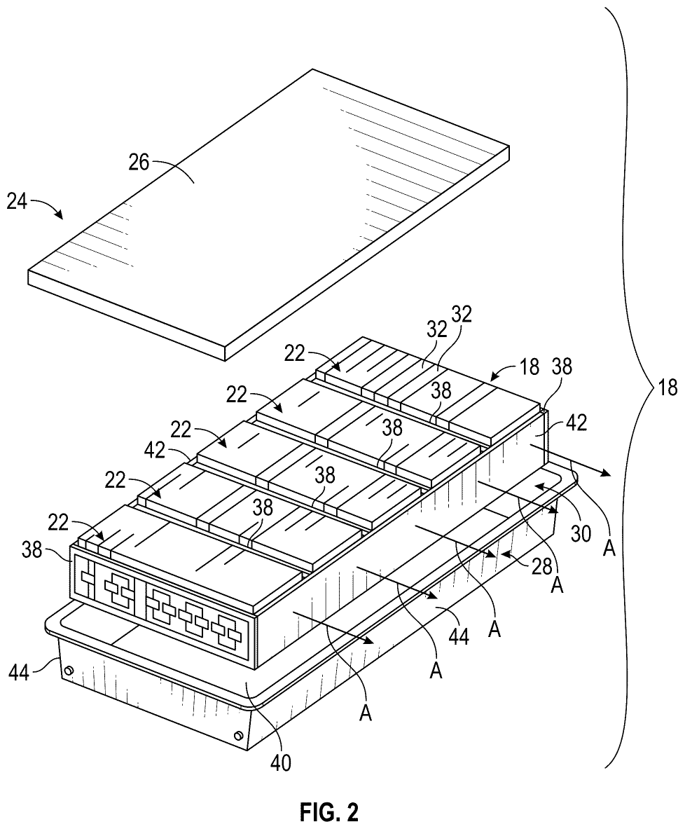

FIG. 2 illustrates additional details associated with the traction battery pack 18 of the electrified vehicle 10 of FIG. 1. The traction battery pack 18 may include a plurality of cell stacks 22 housed within an interior area 30 of an enclosure assembly 24. The enclosure assembly 24 of the traction battery pack 18 may include an enclosure cover 26 and an enclosure tray 28. The enclosure cover 26 may be secured (e.g., bolted, welded, adhered, etc.) to the enclosure tray 28 to provide the interior area 30 for housing the cell stacks 22 and other battery internal components of the traction battery pack 18.

Each cell stack 22 may include a plurality of battery cells 32. The battery cells 32 of each cell stack 22 may be stacked together and arranged along a cell stack axis A. The battery cells 32 store and supply electrical power for powering various components of the electrified vehicle 10. Although a specific number of the cell stacks 22 and battery cells 32 are illustrated in the various figures of this disclosure, the traction battery pack 18 could include any number of the cell stacks 22, with each cell stack 22 having any number of individual battery cells 32.

In an embodiment, the battery cells 32 are lithium-ion pouch cells. However, battery cells having other geometries (cylindrical, prismatic, etc.) and/or chemistries (nickel-metal hydride, lead-acid, etc.) could alternatively be utilized within the scope of this disclosure. The exemplary battery cells 32 can include tab terminals that project outwardly from a battery cell housing. The tab terminals of the battery cells 32 of each cell stack 22 are connected to one another, such as by one or more busbars, for example, in order to provide the voltage and power levels necessary for achieving electric vehicle propulsion.

The battery cells 32 of each cell stack 22 may be arranged to extend between a pair of cross-member assemblies 38. Among other functions, the cross-member assemblies 38 may be configured to hold the battery cells 32 and at least partially delineate the cell stacks 22 from one another within the interior area 30 of the enclosure assembly 24.

Each cross-member assembly 38 may be configured to transfer a load applied to a side of the electrified vehicle 10, for example, for ensuring that the battery cells 32 do not become overcompressed. Each cross-member assembly 38 may be further configured to accommodate tension loads resulting from expansion and retraction of the battery cells 32. The cross-member assemblies 38 described herein are therefore configured to increase the structural integrity of the traction battery pack 18.

A vertically upper side of each cell stack 22 may interface with the enclosure cover 26, and a vertically lower side of each cell stack 22 may interface with a heat exchanger plate 40 that is positioned against a floor of the enclosure tray 28. In another embodiment, the heat exchanger plate 40 may be omitted and the vertically lower side of each cell stack 22 may be received in direct contact with the floor of the enclosure tray 28. Vertical and horizontal, for purposes of this disclosure, are with reference to ground and a general orientation of traction battery pack 18 when installed within the electrified vehicle 10 of FIG. 1.

The cross-member assemblies 38 may be adhesively secured to the enclosure cover 26 and to either the heat exchanger plate 40 or the enclosure tray 28 to seal the interfaces between these neighboring components and to structurally integrate the traction battery pack 18.

The cell stacks 22 may be arranged to extend along their respective cell stack axes A between opposing end plates 42. One or more end plates 42 may be positioned between each end of each cell stack 22 and a longitudinally extending side wall 44 of the enclosure tray 28. The end plates 42 may therefore extend along axes that are substantially transverse (e.g. perpendicular) to the cell stack axes A of the cell stacks 22 and to the cross-member assemblies 38. In some implementations, the end plates 42 are structural megabar members that span across a majority of the length of the longitudinally extending side wall 44 of the enclosure tray 28. However, other configurations are contemplated within the scope of this disclosure.

In an embodiment, the cell stacks 22 and the cross-member assemblies 38 extend longitudinally in a cross-vehicle direction of the electrified vehicle 10, and the end plates 42 extend longitudinally in a length-wise direction of the electrified vehicle 10. However, other configurations are contemplated within the scope of this disclosure.

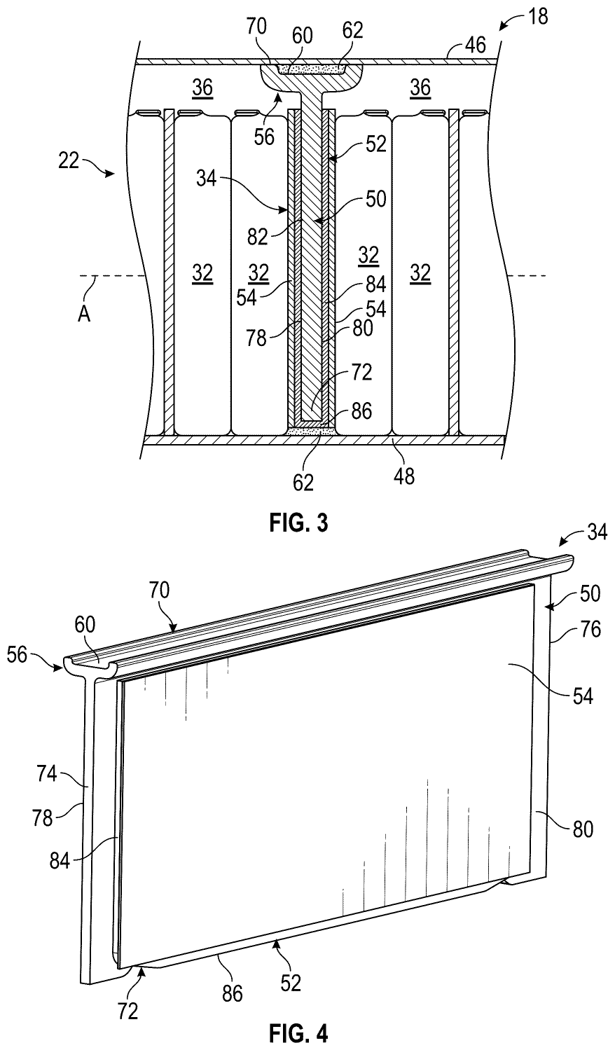

Referring now to FIGS. 3-4, with continued reference to FIGS. 1-2, one or more thermal barrier assemblies 34 may be arranged along the respective cell stack axis A of each cell stack 22. The thermal barrier assemblies 34 may compartmentalize each cell stack 22 into two or more groupings or compartments 36 of battery cells 32. Each compartment 36 may hold one or more of the battery cells 32 of the cell stack 22.

Should, for example, a battery thermal event occur in one of the cell stacks 22, the thermal barrier assemblies 34 may reduce or even prevent thermal energy associated with the thermal event from moving from cell-to-cell, compartment-to-compartment, and/or cell stack-to-cell stack, thereby inhibiting the transfer of thermal energy inside the traction battery pack 18. As further explained below, the thermal barrier assemblies 34 may be further configured to seal an interface between each thermal barrier assembly 34 and its perimeter environment (e.g., neighboring structures of the cell stack 22 and/or traction battery pack 18).

Each thermal barrier assembly 34 of the cell stack 22 may include a structural barrier 50, a thermal resistance material wrapping 52, and foam layers 54 as part of a multi-layered structure of the thermal barrier assembly 34. In the illustrated embodiment, the thermal resistance material wrapping 52 is at least partially wrapped, folded, or otherwise arranged around the structural barrier 50, and the foam layers 54 may be positioned outboard of the thermal resistance material wrapping 52. The foam layers 54 may thus flank sections of the thermal resistance material wrapping 52 and can be positioned in abutting contact with major side surfaces of battery cells 32 located in adjacent compartments 36 of the cell stack 22.

The structural barrier 50 may include a thermoplastic structure or a polymer composite structure (e.g., glass fiber reinforced polypropylene with an intumescent additive), for example, the thermal resistance material wrapping 52 may include aerogel or mica, for example, and the foam layers 54 may include polyurethane foam or silicone foam, for example. However, other materials or combinations of materials could be utilized to construct the subcomponents of the thermal barrier assembly 34 within the scope of this disclosure.

As will be appreciated by persons of ordinary skill in the art having the benefit of this disclosure, the exemplary thermal barrier assemblies shown in the various figures are not necessarily drawn to scale. Certain aspects of the thermal barrier assembly 34 have been exaggerated to better illustrate its substituent components and their arrangement relative to one another.

The structural barrier 50 of the thermal barrier assembly 34 may be a pultrusion, which implicates structure to this component. A person of ordinary skill in the art having the benefit of this disclosure would understand how to structurally distinguish a pultruded structure from another type of structure, such as an extrusion, for example. The structural barrier 50 may be manufactured as part of a pultrusion process that utilizes a glass or carbon fiber (unidirectional or multidirectional mat) and a thermoset resin. A plurality of glass or carbon fiber strands may be pulled through the thermoset resin as part of the pultrusion process for manufacturing the structural barrier 50. In other implementations, the structural barrier 50 could be an injection molded part or an extruded part.

The structural barrier 50 may include a top edge 70, a bottom edge 72, a first lateral side edge 74, and a second lateral side edge 76. Opposing major side faces 78, 80 of the structural barrier 50 each extend between the top edge 70 and the bottom edge 72 and further between the first lateral side edge 74 and the second lateral side edge 76.

In an assembled condition of the cell stack 22, the top edge 70 of the structural barrier 50 faces toward an upper enclosure structure 46 of the traction battery pack 18, the bottom edge 72 faces toward a lower enclosure structure 48 of the traction battery pack 18, the first lateral side edge 74 faces toward one of the cross-member assemblies 38 of the cell stack 22, and the second lateral edge 76 faces toward the other of the cross-member assemblies 38 of the cell stack. The upper enclosure structure 46 may be part of the enclosure cover 26 of the enclosure assembly 24 or could be an intermediate structure (e.g., an actively cooled heat exchanger plate) that is positioned between the thermal barrier assembly 34 and the enclosure cover 26. The lower enclosure structure 48 may be part of the actively cooled heat exchanger plate 40 that is positioned between the structural thermal barrier assembly 34 and the enclosure tray 28, or could alternatively be part of the enclosure tray 28 or an array enclosure structure.

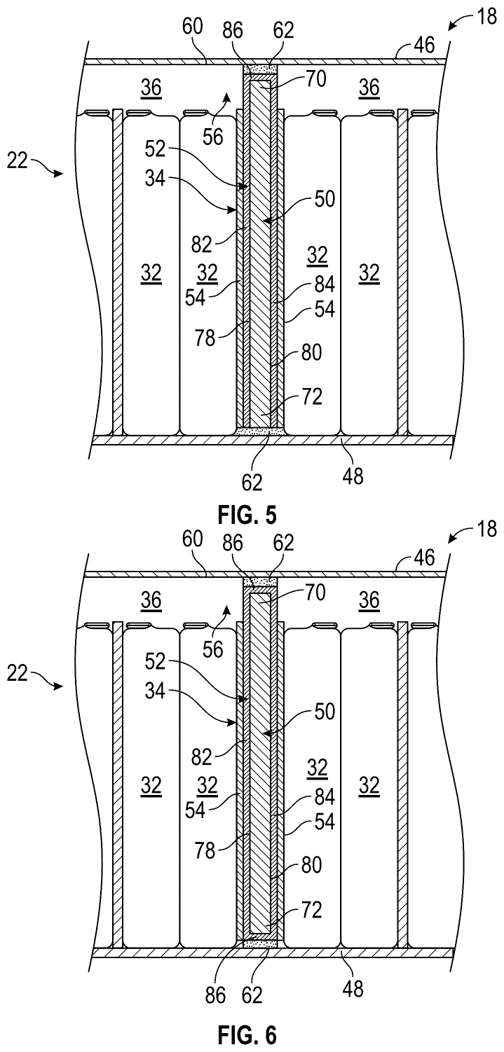

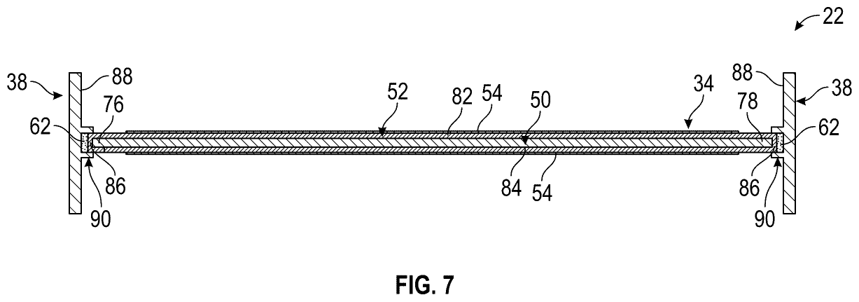

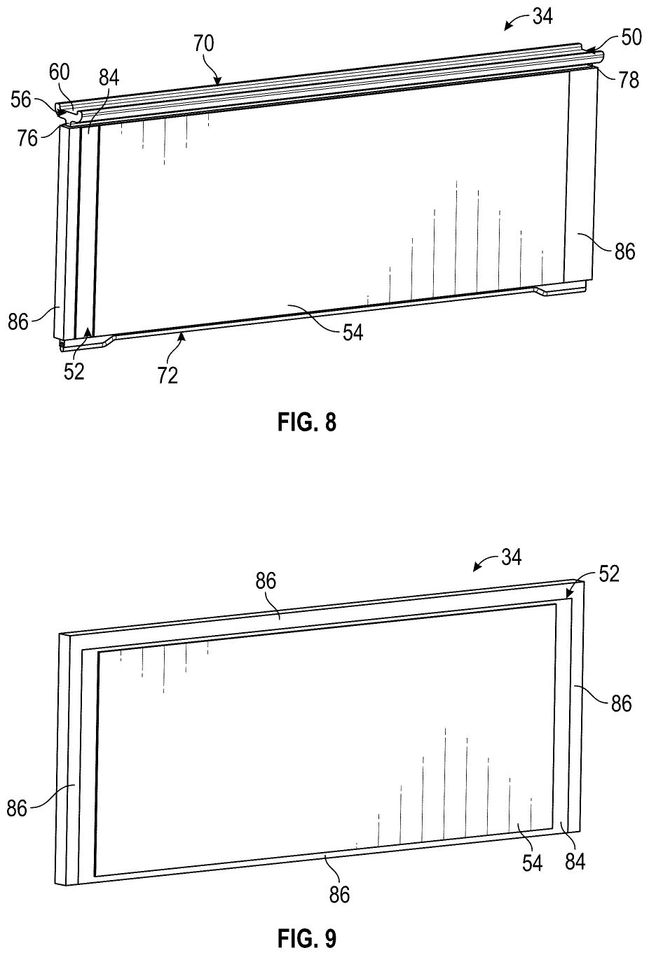

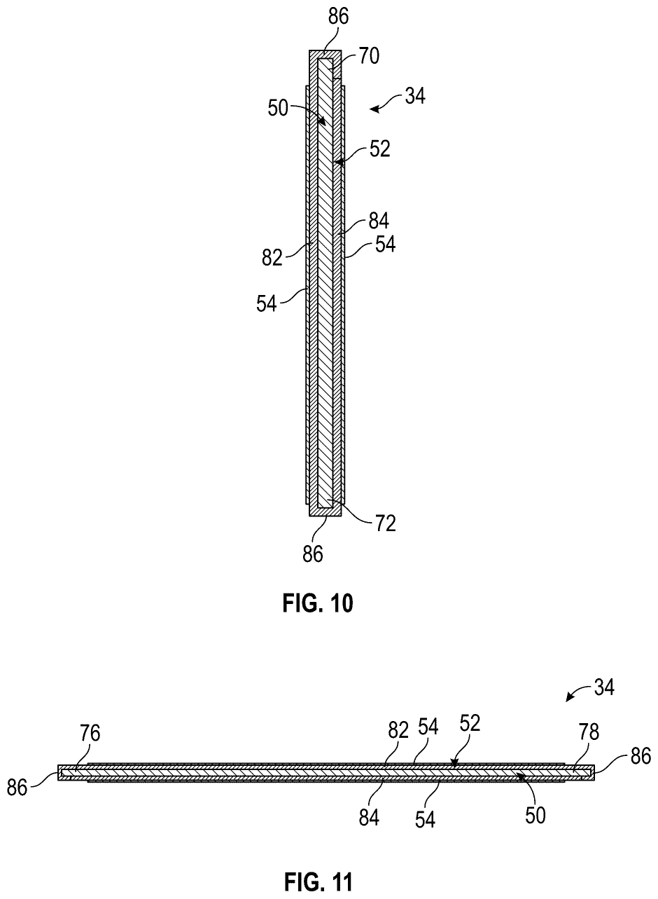

The thermal resistance material wrapping 52 may be wrapped or folded around one or more of the top edge 70, the bottom edge 72, the first lateral side edge 74, and the second lateral side edge 76 of the structural barrier 50 in order to seal an interface between the thermal barrier assembly 34 and its perimeter environment. In an embodiment, the thermal resistance material wrapping 52 is wrapped around the bottom edge 72 of the structural barrier 50 (see FIGS. 3-4). In another embodiment, the thermal resistance material wrapping 52 is wrapped around the top edge 70 of the structural barrier 50 (see FIG. 5). In another embodiment, the thermal resistance material wrapping 52 is wrapped around the both the top edge 70 and the bottom edge 72 of the structural barrier 50 (see FIG. 6). In another embodiment, the thermal resistance material wrapping 52 is wrapped around both the first lateral side edge 74 and the second lateral side edge 76 of the structural barrier 50 (see FIGS. 7-8). In yet another embodiment, the thermal resistance material wrapping 52 is wrapped around each of the top edge 70, the bottom edge 50, the first lateral side edge 74, and the second lateral side edge 76 of the structural barrier 50 (see FIGS. 9-11).

The thermal resistance material wrapping 52 may include a first section 82, a second section 84, and one or more sealing sections 86 that connects between the first section 82 and the second section 84. The first section 82 may substantially cover the major side face 78 of the structural barrier 50, and the second section 84 may substantially cover the major side face 80 of the structural barrier 50. One foam layer 54 may flank the first section 82, and another other foam layer 54 may flank the second section 84.

Each sealing section 86 may provide the portion of the thermal resistance material wrapping 52 that is wrapped around the top edge 70, the bottom edge 72, the first lateral side edge 74, or the second lateral side edge 76 of the structural barrier 50. The sealing sections 86 may be configured to seal the interface between the thermal barrier assembly 34 and the upper enclosure structure 46, the lower enclosure structure 48, and/or the cross-member assemblies 38.

In implementations in which the thermal resistance material wrapping 52 is not arranged to wrap around the top edge 70 of the structural barrier 50 (see, e.g., FIGS. 3-4 and 8), the structural barrier 50 of the thermal barrier assembly 34 may include an upper interfacing structure 56 that is configured to interface with the upper enclosure structure 46. The upper interfacing structure 56 may include a dish-like basin 60 for receiving and holding an adhesive 62 for securing the thermal barrier assembly 34 to the upper enclosure structure 46. The adhesive 62 may be an epoxy based adhesive or a urethane based adhesive, for example. Once the upper interfacing structure 56 is secured relative to the upper enclosure structure 46, the thermal barrier assembly 34 can substantially prevent thermal energy from moving from one compartment 36 to another at the sealed interface between the thermal barrier assembly 34 and the upper enclosure structure 46, such as during a battery thermal event, for example. An additional amount of the adhesive 62 may optionally be provided between each scaling section 86 of the thermal resistance material wrapping 52 and its neighboring structure for further sealing the thermal barrier assembly 34 to the perimeter environment.

In implementations in which the thermal resistance material wrapping 52 is arranged to wrap around the first lateral side edge 74 and the second lateral side edge 76 of the structural barrier 50 (see, e.g., FIGS. 7-11), the sealing sections 86 of the thermal resistance material wrapping 52 may seal the interfaces between the thermal barrier assembly 34 and each cross-member assembly 38 of the cell stack 22. Each cross-member assembly 38 may include an interior facing surface 88 (e.g. the surface that faces toward the battery cells 32 and the thermal barrier assemblies 34). The interior facing surface 88 may include a C-channel 90 that is sized to accommodate the sealing section 86. An adhesive 62 may optionally be applied between each sealing section 86 and C-channel 90 for establishing a sealed interface between the thermal barrier assembly 34 and the cross-member assembly 38.

The thermal barrier assemblies of this disclosure may function to both mitigate the transfer of thermal energy and establish a sealed interface relative to a perimeter environment. The exemplary thermal barrier assemblies may include a thermal resistance material wrapping for providing the barrier sealing functions.

Although the different non-limiting embodiments are illustrated as having specific components or steps, the embodiments of this disclosure are not limited to those particular combinations. It is possible to use some of the components or features from any of the non-limiting embodiments in combination with features or components from any of the other non-limiting embodiments.

It should be understood that like reference numerals identify corresponding or similar elements throughout the several drawings. It should be understood that although a particular component arrangement is disclosed and illustrated in these exemplary embodiments, other arrangements could also benefit from the teachings of this disclosure.

The foregoing description shall be interpreted as illustrative and not in any limiting sense. A worker of ordinary skill in the art would understand that certain modifications could come within the scope of this disclosure. For these reasons, the following claims should be studied to determine the true scope and content of this disclosure.

What is claimed is:

1. A traction battery pack, comprising:
a thermal barrier assembly arranged to partition a battery cell stack into a first compartment and a second compartment, the thermal barrier assembly including:
a structural barrier; and
a thermal resistance material wrapping that is wrapped around at least one edge of the structural barrier.

2. The traction battery pack as recited in claim 1, wherein the thermal resistance material wrapping is wrapped around a bottom edge of the structural barrier to seal an interface between the thermal barrier assembly and a lower enclosure structure of the traction battery pack.

3. The traction battery pack as recited in claim 2, wherein the lower enclosure structure is part of a heat exchanger plate.

4. The traction battery pack as recited in claim 1, wherein the thermal resistance material wrapping is wrapped around a top edge of the structural barrier to seal an interface between the thermal barrier assembly and an upper enclosure structure of the traction battery pack.

5. The traction battery pack as recited in claim 4, wherein the upper enclosure structure is part of an enclosure cover of an enclosure assembly of the traction battery pack.

6. The traction battery pack as recited in claim 1, wherein the thermal resistance material wrapping is wrapped around a top edge of the structural barrier to seal a first interface between the thermal barrier assembly and an upper enclosure structure of the traction battery pack and is further wrapped around a bottom edge of the structural barrier to seal a second interface between the thermal barrier assembly and a lower enclosure structure of the traction battery pack.

7. The traction battery pack as recited in claim 1, wherein the thermal resistance material wrapping is wrapped around a lateral side edge of the structural barrier to seal an interface between the thermal barrier assembly and a cross-member assembly of the battery cell stack.

8. The traction battery pack as recited in claim 1, wherein the thermal resistance material wrapping is wrapped around a first lateral side edge of the structural barrier to seal a first interface between the thermal barrier assembly and a first cross-member assembly of the battery cell stack and is further wrapped around a second lateral side edge of the structural barrier to seal a second interface between the thermal barrier assembly and a second cross-member assembly of the battery cell stack.

9. The traction battery pack as recited in claim 1, wherein the thermal resistance material wrapping is wrapped around a top edge of the structural barrier to seal a first interface between the thermal barrier assembly and an upper enclosure structure of the traction battery pack, is further wrapped around a bottom edge of the structural barrier to seal a second interface between the thermal barrier assembly and a lower enclosure structure of the traction battery pack, is further wrapped around a first lateral side edge of the structural barrier to seal a third interface between the thermal barrier assembly and a first cross-member assembly of the battery cell stack, and is further wrapped around a second lateral side edge of the structural barrier to seal a fourth interface between the thermal barrier assembly and a second cross-member assembly of the battery cell stack.

10. The traction battery pack as recited in claim 1, wherein the thermal resistance material wrapping includes a first section that covers a majority of a first major side face of the structural barrier, a second section that covers a majority of a second major side face of the structural barrier, and a sealing section that connects between the first section and the second section.

11. The traction battery pack as recited in claim 10, wherein the thermal barrier assembly includes a first foam layer that flanks the first section of the thermal resistance material wrapping and a second foam layer that flanks the second section of the thermal resistance material wrapping.

12. The traction battery pack as recited in claim 1, comprising an adhesive applied between the thermal resistance material wrapping and a perimeter environment.

13. The traction battery pack as recited in claim 1, wherein the structural barrier includes a pultrusion.

14. A traction battery pack, comprising:
an upper enclosure structure;
a lower enclosure structure;
a first cross-member assembly;
a second cross-member assembly;
a first grouping of battery cells and a second grouping of battery cells arranged to extend between the upper enclosure structure and the lower enclosure structure and between the first cross-member assembly and the second cross-member assembly; and
a thermal barrier assembly positioned to separate the first grouping of battery cells from the second grouping of battery cells, wherein the thermal barrier assembly includes a structural barrier and a thermal resistance material wrapping arranged about at least one edge of the structural barrier to seal an interface between the thermal barrier assembly and at least one of the upper enclosure structure, the lower enclosure structure, the first cross-member assembly, or the second cross-member assembly.

15. The traction battery pack as recited in claim 14, wherein the thermal resistance material wrapping is wrapped around a bottom edge of the structural barrier to seal the interface between the thermal barrier assembly and the lower enclosure structure.

16. The traction battery pack as recited in claim 14, wherein the thermal resistance material wrapping is wrapped around a top edge of the structural barrier to seal the interface between the thermal barrier assembly and the upper enclosure structure.

17. The traction battery pack as recited in claim 14, wherein the thermal resistance material wrapping is wrapped around a top edge of the structural barrier to seal a first interface between the thermal barrier assembly and the upper enclosure structure and is further wrapped around a bottom edge of the structural barrier to seal a second interface between the thermal barrier assembly and the lower enclosure structure.

18. The traction battery pack as recited in claim 14, wherein the thermal resistance material wrapping is wrapped around a first lateral side edge of the structural barrier to seal a first interface between the thermal barrier assembly and the first cross-member assembly and is further wrapped around a second lateral side edge of the structural barrier to seal a second interface between the thermal barrier assembly and the second cross-member assembly.

19. The traction battery pack as recited in claim 14, wherein the thermal resistance material wrapping is wrapped around a top edge of the structural barrier to seal a first interface between the thermal barrier assembly and the upper enclosure structure, is further wrapped around a bottom edge of the structural barrier to seal a second interface between the thermal barrier assembly and the lower enclosure structure, is further wrapped around a first lateral side edge of the structural barrier to seal a third interface between the thermal barrier assembly and the first cross-member assembly, and is further wrapped around a second lateral side edge of the structural barrier to seal a fourth interface between the thermal barrier assembly and the second cross-member assembly.

20. The traction battery pack as recited in claim 14, comprising an adhesive applied between a portion of the thermal resistance material wrapping that is arranged about the at least one edge of the structural barrier and the upper enclosure structure, the lower enclosure structure, the first cross-member assembly, or the second cross-member assembly.
